(19) United States
(12) Patent Application Publication
(10) Pub. No.: US 2025/0047311 A1
(43) Pub. Date: Feb. 6, 2025

(54) WIRELESS METRIC BASED DUAL BAND COMMUNICATION

(71) Applicant: Hewlett-Packard Development Company, L.P., Spring, TX (US)

(72) Inventors: Cheng-Fang Lin, Taipei City (TW); Huai-Yung Yen, Taipei City (TW); Ruei-Ting Lin, Taipei City (TW); Ren-Hao Chen, Taipei City (TW); Lo-Chun Tung, Taipei City (TW); Yao-Cheng Yang, Taipei City (TW)

(73) Assignee: Hewlett-Packard Development Company, L.P., Spring, TX (US)

(21) Appl. No.: 18/716,060

(22) PCT Filed: Dec. 17, 2021
(86) PCT No.: PCT/US2021/064047

§ 371 Date: Jun. 3, 2024

(51) Int. Cl. H04B 1/00; H04B 17/309

(52) U.S. Cl. CPC H04B 1/0064; H04B 17/309

(57) ABSTRACT

In some examples, the disclosure describes an electronic device with a processing resource and a memory resource storing computer-readable instructions executable by the processing resource to determine a wireless metric associated with a first wireless signal path utilizing concurrent dual wireless bands between an access point and the electronic device and alter the first wireless signal path to a second wireless signal path that utilizes a single band between the access point and the electronic device.

### BACKGROUND

Electronic devices such as notebook computers, tablet computers, smart phones, etc. can communication wirelessly. However, during wireless communication, an electronic device may emit radio frequency (RF) energy that is absorbed by or otherwise impacts tissues of a user of the electronic device. Such RF energy absorption may cause harm to the user.

### BRIEF DESCRIPTION OF THE DRAWINGS

FIG. 1 illustrates a diagram of an example of an electronic device including antennas suitable with wireless metric based dual band communication.

FIG. 2 illustrates a diagram of another example of an electronic device including antennas suitable with wireless metric based dual band communication.

FIG. 3 illustrates a diagram of a non-transitory computer-readable medium suitable with wireless metric based dual band communication.

FIG. 4 illustrates a diagram of an example of a wireless management controller suitable with wireless metric based dual band communication.

FIG. 5 illustrates an example of a flow diagram of a flow for providing wireless metric based dual band communication.

FIG. 6 illustrates a diagram of another example of an electronic device including antennas suitable with wireless metric based dual band communication.

FIG. 7 illustrates a graph representing an example of wireless metric based dual band communication.

### DETAILED DESCRIPTION

Electronic devices utilize a wireless local area network (WLAN) and/or a wireless wide area network (WWAN) to communicate data wirelessly. For instance, wireless communications utilizing a WLAN typically occur in accordance with the Institute of Electrical and Electronics Engineers (IEEE) 802.11x (where x is a, b, g, n, ax) standards. WLAN communications can use various different frequency bands.

Some electronic devices utilize dual band communications to exchange data with other devices. For example, dual band communication can concurrently utilize a first antenna operating at the 2.4 GHz band and a second antenna operating at a 5 GHz band to wirelessly communicate data with another device such as an access point. However, signal path loss may negatively impact dual band communications. For instance, variations in an operating environment such as a change in an amount of distance between an electronic device and another device communicating with the electronic device can impact an amount of signal path loss. Signal path loss may degrade or interrupt the transfer of data between a transmitter and a receiver. For example, signal path loss of radio waves may degrade or interrupt data communication between an access point (AP) and an electronic device. Signal path loss increases as a distance between the AP and the electronic device increases. As a result, data throughput (Tput) such as a quantity of megabits per second (Mbps) between the electronic device and the access point can be reduced.

Moreover, an amount of signal path loss can be exacerbated when an electronic device is operated in accordance with a specific absorption rate (SAR) threshold. SAR is a measure of the rate at which energy is absorbed by the human body when exposed to a radio frequency electromagnetic field. For example, in the United States, the SAR threshold for public exposure to radio frequency (RF) energy from an electronic device is 1.6 watts per kilogram. To comply with a SAR threshold, an electronic device may reduce RF output power of communication components (e.g., transceivers) when the electronic device is within a certain distance of a user of the electronic device. In any case, output power of the electronic device is reduced to ensure compliance with the SAR threshold and therefore any signal loss is exacerbated in contrast to approaches not constrained by operation in accordance with a SAR threshold.

Accordingly, wireless metric based dual band communication, as detailed herein, accounts for signal path loss experienced by an electronic device which is operated in accordance with a SAR threshold. Thus, approaches herein provide enhanced wireless communication (e.g., higher Tput) than other approaches such as those that employ dual band communication whenever possible. Moreover, approaches herein can be tailored to a particular type of electronic device. For instance, a wireless metric threshold can be determined based on a given antenna configuration (e.g., a given distance between antennas) in an electronic device, as detailed herein.

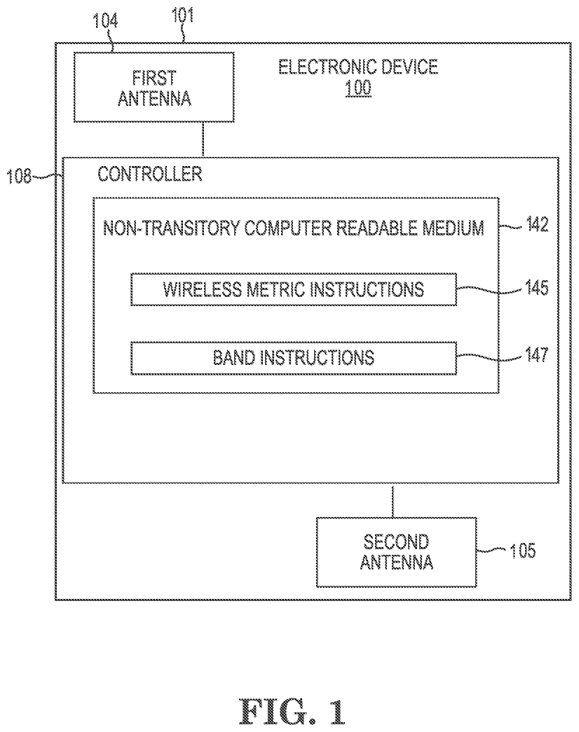

FIG. 1 illustrates a diagram of an example of an electronic device 100 including antennas suitable with wireless metric based dual band communication. Examples of the electronic device 100 include a mobile phone, a tablet, a laptop computer, a display member, an all-in-one (AIO) computer, a desktop computer, or combinations thereof. As used herein, an AIO computer refers to a computer which integrates the internal components into the same case as a display member and offers the touch input functionality of the tablet devices while also providing the processing power and viewing area of desktop computing systems.

A housing 101 forms an exterior surface of the electronic device 100. Examples of suitable housing 101 materials include fabric, metal, wood, plastic, or combinations thereof, among other suitable materials.

The electronic device 100 includes a first antenna 104 and a second antenna 105. As used herein, an antenna refers to a hardware device that is to radiate and/or receive radio waves. For instance, an antenna may be implemented using a metallic material that acts as an electrical conductor. Examples of antennas include dipole antennas, monopole antennas, an antenna array, patch antennas, loop antennas, etc. The first antenna 104 and the second antenna 105 can be the same type of antenna or different types of antennas. For instance, the first antenna 104 and the second antenna 105 can each be WLAN antennas. As used herein, WLAN antennas refer to antennas that are to communicate wirelessly with various components such as access points on a WLAN.

The electronic device 100 can communicate with the first antenna 104 and the second antenna 105 in one of the multiple supported bands such as the 2.4 GHz band or the 5 GHz band. For example, the first antenna 104 at a first location in the housing 101 of the electronic device 100 can communicate in a first band (e.g., a 2.4 GHz band) and the second antenna 105 at a second location in the electronic device 100 can communicate in a second band (e.g., a 5 GHz band), as detailed herein. In some examples, the first antenna 104 can communicate in a first band (e.g., a low band such as a 2.4 GHz band) and the second antenna 105 can communicate substantially concurrently in a second band (e.g., a high band such as a 5 GHz band or 6 GHz band). Having the first antenna 104 communicate in the first band substantially concurrently with the second antenna 105 communicating in a second band that is different than the first band can increase Tput as compared to other approaches that exclusively utilize an individual band.

However, the disclosure is not so limited. For instance, in some examples an individual (i.e., single) antenna can communicate in a first band and communicate substantially concurrently in a second band. For instance, an individual antenna such as the first antenna 104 or the second antenna 105 can communicate in a first band (e.g., a low band such as a 2.4 GHz band) substantially concurrently with communications in a second band (e.g., a high band such as a 5 GHz band or a 6 GHz band). Having the first antenna 104 communicate in the first band substantially concurrently with a second band that is different than the first band can increase Tput and/or reduce an overall physical footprint and/or cost of the electronic device 100 as compared to other approaches the exclusively utilize an individual band and/or other approaches that utilize a plurality of antennas to communicate in multiple bands.

As used herein, the term “substantially” means that the characteristic need not be absolute, but is close enough so as to achieve the advantages of the characteristic. For example, “substantially concurrently” is not limited to operations that are performed absolutely concurrently and can include timings that are intended to be concurrently but due to variances in a type/amount of data and/or environmental factors, etc. may not be precisely concurrently. For example, due to differences in various interfaces, antennas that are utilized “substantially concurrently” may not start or finish at exactly the same time. For example, the antennas can be utilized such that they are transmitting and/or receiving data at the same time regardless of whether one of the antennas commences or terminates data transmission/reception prior to the other antenna.

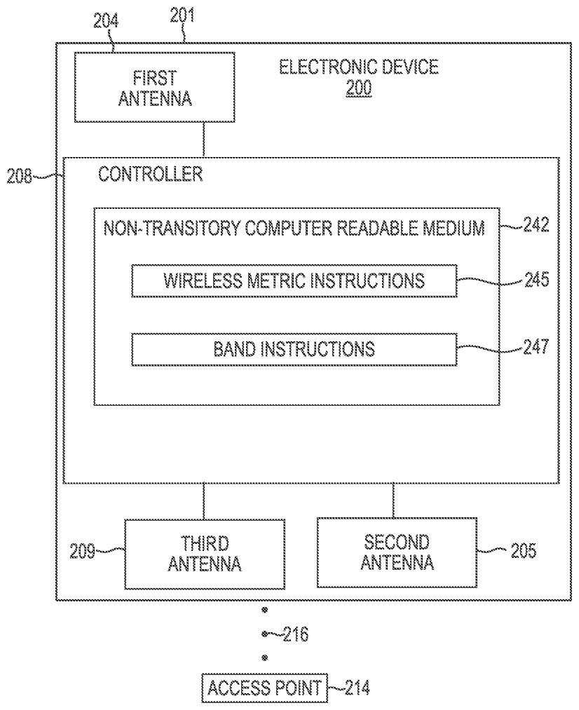

The electronic device 100 can include any number of antennas. For instance, in addition to the first antenna 104 and the second antenna 105, the electronic device 100 can include a third antenna (e.g., a third antenna 209 as illustrated in FIG. 2).

The antennas in the electronic device 100 can be connected to wireless transmitter (not shown) and/or a wireless receiver (not shown). A wireless transmitter refers to circuitry that converts information and/or a signal to be communicated as a radio frequency alternating current via modulation (e.g., complementary coded keying, quadrature phase shift keying, orthogonal frequency division multiplex modulation scheme, etc.). When an antenna is excited by the radio frequency alternating current, the antenna may radiate the information and/or signal in the radio frequency alternating current as radio waves. A wireless receiver refers to circuitry that receives radio waves via the antenna and coverts information or signals carried in the radio waves to a form useable by a wireless management controller 108. In some examples, wireless receiver and wireless transmitter may be integrated as a single device, such as a transceiver.

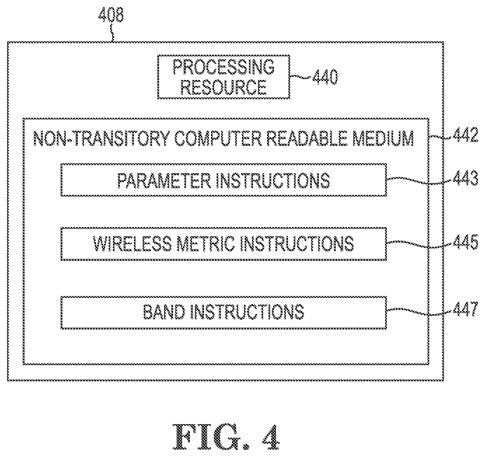

The wireless management controller 108 is coupled to the first antenna 104, the second antenna 105, the wireless transmitter and/or the wireless receiver. For instance, the wireless management controller 108 can be coupled to the first antenna 104 and the second antenna 105, as illustrated in FIG. 1. In some examples, the wireless management controller 108 can be coupled to each of the first antenna 104, the second antenna 105, the wireless transmitter and the wireless receiver. As detailed herein, the controller 108 includes a non-transitory computer-readable medium 142 suitable with wireless metric based dual band communication. The medium 142 stores instructions 145 that are executable by a processing resource (e.g., processing resource 440, as illustrated in FIG. 4) to determine a wireless metric associated with a first wireless signal path utilizing concurrent dual wireless bands between an access point and the electronic device, as detailed herein. The medium 142 stores instructions 147 to alter the first wireless signal path to a second wireless signal path that utilizes a single band between the access point and the electronic device, as detailed herein.

FIG. 2 illustrates a diagram of another example of an electronic device 200 including antennas suitable with wireless metric based dual band communication. Electronic device 200 can be analogous to or similar to electronic device 100 as illustrated in FIG. 1. For instance, electronic device 200 includes a housing 201 that forms an exterior surface of the electronic device 200.

The electronic device 200 includes a first antenna 204, a second antenna 205, and a third antenna 209. While illustrated as being visible for descriptive purposes, the first antenna 204, the second antenna 205, and the third antenna 209 can be located inside of the housing 201, as detailed herein.

As mentioned, the electronic device 200 includes a wireless management controller 208. The controller can be coupled to the first antenna 204, the second antenna 205, and/or the third antenna 209. For instance, as illustrated in FIG. 2, the wireless management controller 208 is coupled to each of the first antenna 204, the second antenna 205, and the third antenna 209. As detailed herein, the controller 208 includes a non-transitory computer-readable medium 242 that stores instructions 245 that are executable by a processing resource to determine a wireless metric associated with a first wireless signal path utilizing concurrent dual wireless bands between an access point and the electronic device, as detailed herein. The medium 242 stores instructions 247 to alter the first wireless signal path to a second wireless signal path that utilizes a single band between the access point and the electronic device, as detailed herein.

As illustrated in FIG. 2, the electronic device 200 can be associated with an access point 214. As used herein, the term “access point (AP)”, can, for example, refer to a networking device that allows an electronic device to connect to a wired or wireless network. An AP can include a processor, memory, and input/output interfaces, including wired network interfaces such as IEEE 802.3 Ethernet interfaces, as well as wireless network interfaces such as IEEE 802.11 wireless interfaces, although examples of the disclosure are not limited to such interfaces. An AP can include memory, including read-write memory, and a hierarch of persistent memory such as ROM, EPROM, and Flash memory.

The electronic device 200 can communicate data with a given device such as the access point 214 via a signal path (as represented by element 216). The signal path 216 can represent a dual band communication such as when an antenna such as the first antenna 204 and/or the second antenna 205 communicates in a first frequency band (e.g., a low band) and a second frequency band (e.g., a high band) with another device such as an access point, in contrast to other approaches that may seek to communicate concurrently in dual bands to a plurality of devices (e.g., a first band with a first device and a second band with a second device).

Similarly in some instances, the signal path 216 can represent communication in an individual (i.e., single) band. For instance, as detailed herein responsive to a determination a wireless metric is less than the wireless metric threshold a first wireless signal path (representing a dual band communication between the electronic device 200 and the access point 214) can be altered to a second wireless signal path that exclusively utilizes a single antenna on a single band between the access point 214 and the electronic device 200. That is, approaches herein selectively utilize a concurrent dual band communication (CDB) mode in which a plurality of bands are utilized concurrently and, notably, can utilize an individual band when a wireless metric of a signal path (e.g., the signal path of the dual band communication) is less than a wireless metric threshold. As such, approaches herein can realized improved wireless performance (e.g., having higher data throughput) as compared to other approaches that do not use more than one band at a time and/or that use dual band communication whenever possible.

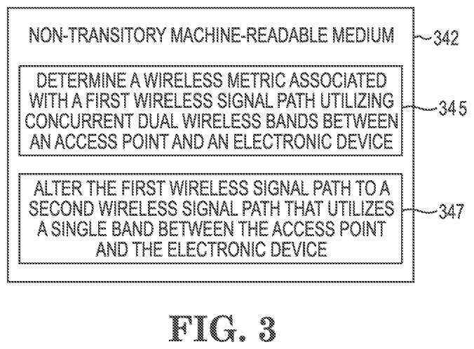

FIG. 3 illustrates a diagram of a non-transitory computer-readable medium 342 suitable with wireless metric based dual band communication. The non-transitory computer-readable medium 342 may be any type of volatile or non-volatile non-transitory memory, such as random-access memory (RAM), flash memory, read-only memory (ROM), storage volumes, a hard disk, or a combination thereof.

The medium 342 stores instructions 345 that are executable by a processing resource (e.g., processing resource 440, as illustrated in FIG. 4) to determine a wireless metric associated with a first wireless signal path utilizing concurrent dual wireless bands between an access point and the electronic device, as detailed herein. In some examples, the wireless metric is a Modulation Coding Scheme (MCS) index value. However, use of other wireless metrics is possible.

The processing resource can execute instructions 347 to alter the first wireless signal path to a second wireless signal path that utilizes a single band between the access point and the electronic device, as detailed herein. For instance, the processing resource can execute the instructions 347 in response to a determination that a wireless metric is less than a wireless metric threshold.

For instance, the wireless metric threshold can be equal to a particular MCS index value (e.g., 20). The wireless metric threshold can be stored in the electronic device 200 such as in firmware, BIOS, etc. of the electronic device 200. As detailed herein, the wireless metric threshold can be specific to a type (e.g., laptop, desktop, mobile) of device. For instance, the wireless metric threshold can be specific to a make/model of a laptop, desktop, mobile phone, and/or other electronic devices.

FIG. 4 illustrates a diagram of an example of a wireless management controller 408 suitable with wireless metric based dual band communication. As illustrated in FIG. 4, the wireless management controller 408 includes a processing resource 440 and a non-transitory computer readable medium 442.

The processing resource 440 includes a central processing unit (CPU), a semiconductor based microprocessor, and/or other hardware devices suitable for retrieval and execution of computer-readable instructions such as those stored on the non-transitory computer readable medium 442. The term “non-transitory” does not encompass transitory propagating signals.

As mentioned, the non-transitory computer readable medium 442 is any electronic, magnetic, optical, or other physical storage device that stores executable instructions. For example, non-transitory computer readable medium 442 in some instances is a Random Access Memory (RAM), an Electrically-Erasable Programmable Read-Only Memory (EEPROM), a storage drive, an optical disc, and the like.

The executable instructions are “installed” on the wireless management controller 408 illustrated in FIG. 4 and/or “downloadable” to the controller as a portable, external, or remote storage medium, for example, that allows the wireless management controller 408 to download instructions from the portable/external/remote storage medium. In this situation, the executable instructions are part of an “installation package”. As described herein, non-transitory computer readable medium 442 is encoded with executable instructions related to wireless metric based dual band communication.

The processing resource 440 executes parameter instructions 443 to determine a wireless parameter associated with a first wireless signal path utilizing concurrent dual wireless bands between an access point (e.g., access point 220, as described herein) and an electronic device (e.g., electronic device 100, electronic device 200, and/or electronic device 600, as described herein). For instance, the processing resource 440 can receives respective signals from the antenna and/or circuitry coupled to the antenna that are indicative of a real-time wireless parameters associated with the first wireless signal path that is utilizing concurrent dual wireless bands.

As mentioned, in some examples the concurrent dual bands of a signal path between an access point and an electronic device include a low band and an upper band. In such examples, the real-time wireless parameter can be determined for the low band, the high band, or a combination thereof. For instance, in some examples the parameter instructions 443 are executed to determine a real-time wireless parameter of the low band. In some examples, the parameter instructions 443 are executed to determine a real-time wireless parameter of the high band. In some examples, the parameter instructions 443 are executed to determine a first real-time wireless parameter of a high band and to determine a second real-time wireless parameter of a low band.

In some instances, the parameter instructions 443 are executed to periodically determine the wireless parameter, for instance, periodically during a session of use of the electronic device and/or during a period of time that the electronic device is associated with an access point. However, in some instances, the real-time wireless parameters are determined responsive to an input (e.g., an input provided by the user of the electronic device), among other possibilities.

The processing resource 440 executes wireless metric instructions 445 to determine, based on the parameter, a wireless metric associated with the wireless signal path. For instance, a parameter can have a corresponding wireless metric in a data storage component such as a look-up table. For instance, for a given set of known conditions (e.g., a given modulation, coding, etc.) a corresponding wireless metric for a given parameter can be determined.

The processing resource 440 can execute instructions to compare the determined wireless metric to a wireless metric threshold. For instance, a wireless metric such as a value indicative of a quality of a wireless connection are compared to a value/and/percentage of the wireless metric threshold. Such comparison determines whether or not the wireless metric (e.g., a MCS index value of 24) is less than a wireless metric threshold (e.g., a MCS index value of 20).

The processing resource 440 executes band instructions 447 to alter a first wireless signal path to a second wireless signal path that exclusively utilizes a single antenna on a single band between the access point and the electronic device. For instance, responsive to the determination the wireless metric is less than the wireless metric threshold, the processing resource 440 executes band instructions 447 to alter a first wireless signal path to a second wireless signal path that exclusively utilizes a single antenna on a single band between the access point and the electronic device. As mentioned, altering a first wireless signal path to a second wireless signal path that exclusively utilizes a single antenna on a single band can provide an enhanced second wireless path (e.g., having higher Tput as compared to the dual band communication conducted while at the same wireless metric)

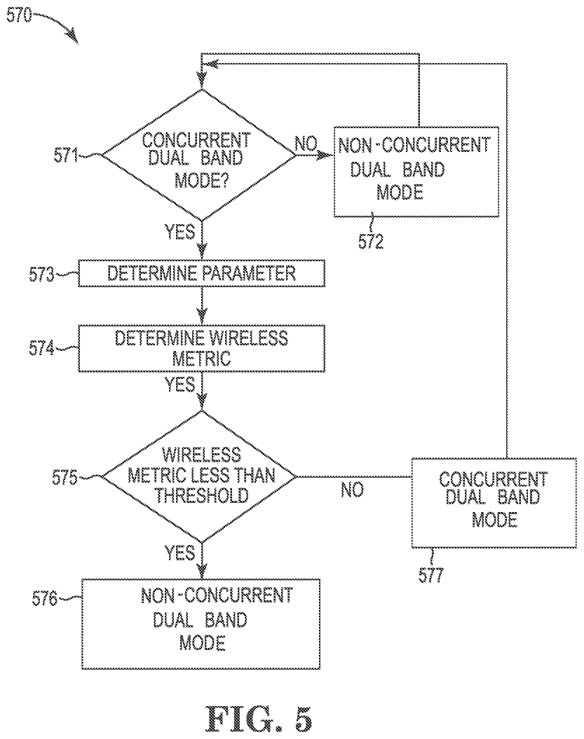

FIG. 5 illustrates an example of a flow diagram of a flow 570 for providing wireless metric based dual band communication. At 571, the flow includes determination of whether an electronic device is transmitting utilizing a CDB mode. The determination can be based on an amount of power utilized by an antenna and/or an amount of data communicated by an antenna. For instance, in instances where a low band antenna and a high band antenna are utilizing more than a threshold amount of current and/or transmitting more than a threshold amount of data it can be determined that the electronic device is utilizing a CDB mode.

Responsive to a determination that the electronic device is transmitting utilizing a non-concurrent dual band mode (e.g., using a single band) the electronic device can continue to use the non-concurrent dual band mode (non-CBD mode), as indicated at 572. In such instances, periodically or responsive to an input it can be determined whether the electronic device is transmitting in the CDB mode. In this way, the transmission of the electronic device can be monitored (e.g., periodically monitored) to determine when the electronic device is transmitting in the CDB mode.

Responsive to a determination that the electronic device is transmitting in CDB mode a wireless parameter is determined, as indicated at 573. The wireless parameter can be a real-time wireless parameter of the low band, the high band, or a combination thereof. For instance, the wireless parameter can be determined for a high band such as a 5 GHz band. The wireless parameter can include a signal to noise ratio (SNR), a received signal strength indicator (RSSI), or both. For instance, in some examples the wireless parameter is a RSSI.

Responsive to determination of the parameter, a wireless metric is determined, as indicated at 574. As mentioned, a parameter can have a corresponding wireless metric (e.g., a MCS index value) in a look-up table or other mechanism for organizing information. For instance, for a given set of known conditions (e.g., a given modulation, coding, etc.) a corresponding wireless metric for a given parameter can be determined.

Responsive to the determination of the wireless metric, the wireless metric can be compared to a wireless metric threshold, as indicated at 575. The wireless metric threshold can be a given value such as a given MCS index value (e.g., 20, among other possible values). As detailed herein, the wireless metric threshold (e.g., a given MCS index value) can be specific to a particular type of electronic device.

Responsive to a determination that the wireless metric is less than (or equal to) the wireless metric threshold, the CDB mode of the electronic device is altered to a non-CBD mode that utilizes a single antenna on a single band such as a high band (e.g., 5 GHz band), as indicated at 576. Responsive to a determination that the wireless metric is greater than the wireless metric threshold, the electronic device can continue to operate in the CDB mode.

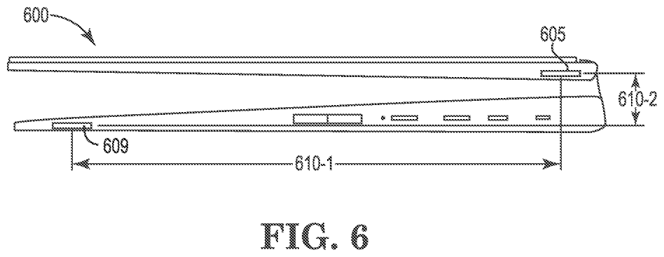

FIG. 6 illustrates a diagram of another example of an electronic device 600 including antennas suitable with wireless metric based dual band communication. FIG. 6 illustrates the electronic device 600 as laptop, however other types of electronic devices are possible. The electronic device 600 includes a display member 603-1 rotatably coupled to a base member 603-2 to permit the display member 603-1 to rotate relative to the base member 603-2 between various positions. For instance, the electronic device 600, as illustrated in FIG. 6, is in a first position in which the electronic device 200 is closed (e.g., the entirety of the display member 603-1 is proximate to the base member 603-2. However, other positions such as having the electronic device be in an open position (e.g., where a portion of the display member 603-1 is rotated a larger distance away from the base member 603-2 than when in the closed position) are possible.

As mentioned, the electronic device and include various types of antennas such as WLAN and/or WWAN antennas. The antennas are located inside a housing of the electronic device. For instance, in the electronic device 600 the antennas are located inside of the display member 203-1, the base member 203-2, or a combination thereof.

In some examples, each antenna of the array of WLAN antennas including a first antenna (not illustrated) and/or the second antenna 605 is located in the display member 603-1 or the base member 603-2 and, in such instances each of the WWAN antennas can be located in the other of the display member 603-1 or the base member 603-2. For instance, each of the WLAN antenna including the second antenna can be located in the display member 603-1 and each WWAN antenna can be located in the base member 603-2, as illustrated in FIG. 6. Such an orientation can reduce any interference between the WLAN antennas and the WWAN antennas be ensuring the respective antennas are a given distance apart. That is, the WLAN antennas such as the second antenna 605 can be a first distance 610-1 (e.g., vertical distance) and a second distance (e.g., a horizontal distance at a normal angle to the vertical distance) way from the WWAN antennas such as the third antenna.

In some examples, a value of the wireless metric threshold is determined. For instance, a wireless metric threshold can be determined based on a distance between a physical location of a first antenna in the electronic device and a physical location of a second antenna in the electronic device. In some examples, the wireless metric threshold can be based on a distance between different types of antennas such as a distance between a WWAN antenna and a WLAN antenna. For examples, the wireless metric threshold can be based on a distance between a WWAN antenna such as the third antenna 609 and the first antenna (not illustrated in FIG. 6), a distance between the WWAN antenna and the second antenna 605, or both. For instance, electronic devices with shorter distances (e.g., the first distance 610-1 and/or the second distance 610-2) between a WWAN antenna and a WLAN antenna can have relatively higher wireless metric thresholds than electronic devices with longer distances between the WWAN antenna and a WLAN antenna, among other possibilities. In electronic devices with arrays of WLAN antenna and/or arrays of WWAN antenna the distance can refer to a distance between whichever WLAN antenna is most proximate to a WLAN antenna, among other possibilities.

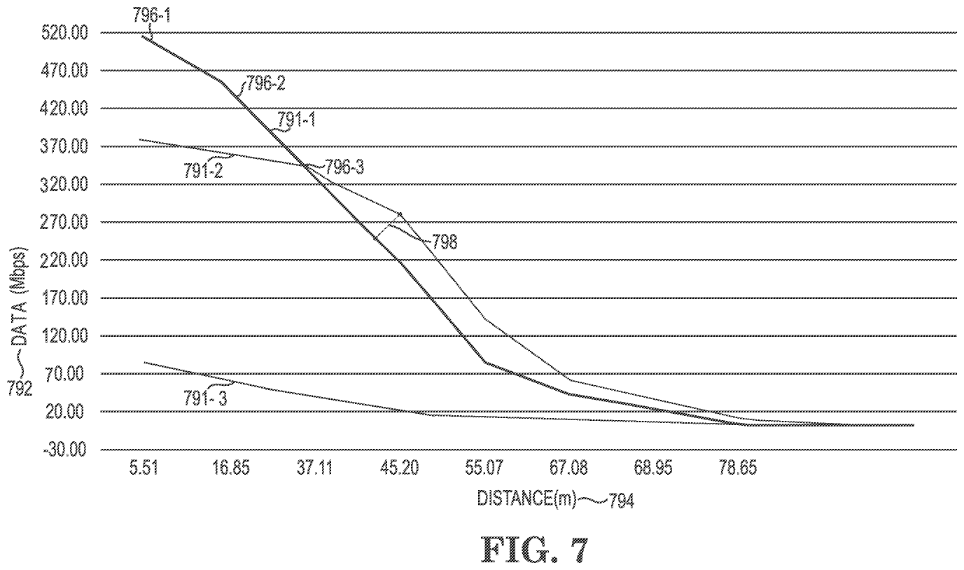

FIG. 7 illustrates a graph representing an example of wireless metric based dual band communication. The graph has a vertical axis 792 representing an amount of data throughput (Tput) in megabytes per second (Mbps) and a horizontal axis 794 representing a distance in meters (m) between an electronic device and another device such as an access point.

As mentioned, an electronic device can communicate (e.g., transmit and receive) data in a CDB mode utilizing dual bands, as represented by 791-1. The electronic device can also communicate data in non-CDB mode utilizing an individual band. For instance, the electronic device can utilize in individual high band (e.g., 5 GHz band) as represented by 791-2 or can utilize an individual low band (e.g., a 2.4 GHz band) as represented by 791-3.

For instance, as illustrated at a first distance 796-1 (e.g., at ˜6 meters) the electronic device can transmit data in a CDB mode and realize a first amount (e.g., ˜515 Mbps) of Tput. The first distance 796-1 can have a corresponding MCS index value. As illustrated at a second distance 796-2 (e.g., at ˜16 meters) the electronic device can transmit data in the CDB mode and realize a second amount (˜425 Mbps) of data throughput. Similarly, as illustrated at a third distance 796-3 (e.g., at ˜37 meters) the electronic device can transmit data in the CDB mode and realize a third amount (˜330 Mbps) of data throughput. That is, as distance increases an amount of Tput decreases, particularly in electronic device which are operated in accordance with a SAR threshold.

Similarly, as distance increases, a given wireless metric value of a wireless signal path utilizing the concurrent dual bands decreases. For instance, at the first distance 796-1 the wireless signal path can have a first value (e.g., a MCS index value of 26) of a wireless metric. Similarly, at the second distance 796-2 the wireless signal path can have a second value (e.g., a MCS index value of 24) of a wireless metric and at the third distance 796-3 the wireless signal path can have a third value (e.g., a MCS index value of 20) of a wireless metric, and so forth.

As illustrated in FIG. 7, at a given wireless metric value an amount of Tput afforded by dual band mode is no longer be greater than using an individual (i.e., single high band). That is, in contrast to other approaches that use a dual band communication “whenever possible”, approaches herein alter the concurrent dual bands of the signal path to exclusively use a second antenna (a high band antenna) to communicate in the second band responsive to a determination that a wireless metric is less than a wireless metric threshold. In this way, approaches herein can realize higher Tput (e.g., equal to a difference 798 between a given Tput utilizing the dual bands 791-1 and a given Tput utilizing the individual high band (e.g., 5 GHZ band) as represented by 791-2) than approaches that merely seek to employ dual band communication whenever possible and/or those that are not able to use dual band communication.

In the foregoing detailed description of the disclosure, reference is made to the accompanying drawings that form a part hereof, and in which is shown by way of illustration how examples of the disclosure. These examples are described in sufficient detail to enable those of ordinary skill in the art to practice the examples of this disclosure, and it is to be understood that other examples (e.g., having a different thickness) are possible and that process, electrical, and/or structural changes can be made without departing from the scope of the disclosure.

The figures herein follow a numbering convention in which the first digit corresponds to the drawing figure number and the remaining digits identify an element or component in the drawing. For example, reference numeral 108 refers to element 108 in FIG. 1 and an analogous element can be identified by reference numeral 208 in FIG. 2. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

What is claimed is:

1. A non-transitory memory resource storing computer-readable instructions executable by a processing resource of an electronic device to:
determine a wireless metric associated with a first wireless signal path utilizing concurrent dual wireless bands between an access point and the electronic device; and
in response to a determination that the wireless metric is less than a wireless metric threshold, alter the first wireless signal path to a second wireless signal path that utilizes a single band between the access point and the electronic device.

2. The memory resource of claim 1, wherein the concurrent dual bands of the signal path include a low band and an upper band.

3. The memory resource of claim 2, wherein the low band is a 2.4 gigahertz (GHz) band.

4. The memory resource of claim 2, wherein the upper band is a 5 gigahertz (GHz) band or a 6.0 GHz band.

5. The memory resource of claim 2, wherein the single band further comprises the upper band.

6. The memory resource of claim 1, further comprising instructions executable by the processing resource to determine the wireless metric threshold, and wherein the wireless metric threshold is determined based on a distance between a physical location of a first antenna in the electronic device and a physical location of a second antenna in the electronic device.

7. The memory resource of claim 6, wherein a larger distance between the physical location of the first antenna in the electronic device and the physical location of the second antenna in the electronic device corresponds to determination of a higher wireless metric threshold.

8. An electronic device including a controller to:
determine a parameter associated with a first wireless signal path utilizing concurrent dual bands including a first band and a second band between an access point and the electronic device;
determine, based on the parameter, a wireless metric associated with the wireless signal path;
determine the wireless metric is less than a wireless metric threshold; and
responsive to the determination the wireless metric is less than the wireless metric threshold, alter the first wireless signal path to a second wireless signal path that exclusively utilizes a single antenna on a single band between the access point and the electronic device.

9. The electronic device of claim 8, wherein the wireless metric further comprises a Modulation Coding Scheme (MCS) index.

10. The electronic device of claim 8, wherein electronic device is to utilize the concurrent dual bands with the single antenna to communicate via the first wireless signal path.

11. An electronic device comprising:
a first antenna at a first location of the electronic device to communicate in a first band;
a second antenna at a second location of the electronic device to communicate in a second band; and
a controller to:
determine a parameter associated with a wireless signal path utilizing concurrent dual bands between an access point and the electronic device associated with the access point, wherein the concurrent dual bands include the first band and the second band;
determine, based on the parameter, a wireless metric associated with the wireless signal path; and
in response to a determination that the wireless metric is less than a wireless metric threshold, alter the concurrent dual bands of the signal path to exclusively use the second antenna to communicate in the second band.

12. The electronic device of claim 11, wherein the wireless metric threshold is specific to a type of the electronic device.

13. The electronic device of claim 12, wherein the first antenna and the second antenna are wireless local area network (WLAN) antennas.

14. The electronic device of claim 13, further comprising a wireless wide area network (WWAN) antenna, and wherein a value of the wireless metric threshold is determined based on a distance between the WWAN antenna and the first antenna, a distance between the WWAN antenna and the second antenna, or both.

15. The electronic device of claim 11, wherein the electronic device is to operate in accordance with a specific absorption rate (SAR) threshold.
